(19) United States
(12) Patent Application Publication
(10) Pub. No.: US 2024/0069195 A1
(43) Pub. Date: Feb. 29, 2024

(54) DISPLACEMENT DETECTOR, ARRAY OF DISPLACEMENT DETECTORS AND METHOD OF MANUFACTURING A DISPLACEMENT DETECTOR

(71) Applicants: Goran STOJANOVIC, Rapperswil (CH); Jean-Francois SEURIN, Princeton Junction, NJ (US); Guoyang XU, Newtown, PA (US); Baiming GUO, Old Bridge, NJ (US); Haisong WANG, Bear, DE (US); Laurent NEVOU, Wadenswil (CH); ams International AG, Jona (CH)

(72) Inventors: Goran STOJANOVIC, Rapperswil (CH); Jean-Francois SEURIN, Princeton Junction, NJ (US); Guoyang XU, Newtown, PA (US); Baiming GUO, Old Bridge, NJ (US); Haisong WANG, Bear, DE (US); Laurent NEVOU, Wadenswil (CH)

(21) Appl. No.: 18/548,934

(22) PCT Filed: Mar. 30, 2022
(86) PCT No.: PCT/US2022/022690

§ 371 Date: Sep. 5, 2023

Related U.S. Application Data
(60) Provisional application No. 63/168,664, filed on Mar. 31, 2021.

(30) Foreign Application Priority Data
May 21, 2021 (DE) 10 2021 113 329.7

(51) Int. Cl. G01S 17/08; G01L 7/08; G01S 7/481; H04R 7/12; H04R 7/18; H04R 19/04; H04R 29/00; H04R 31/00

(52) U.S. Cl. CPC G01S 17/08; G01L 7/086; G01S 7/4814; H04R 7/12; H04R 7/18; H04R 19/04; H04R 29/004; H04R 31/006; H04R 2201/003

(57) ABSTRACT

A displacement detector may include a substrate and a membrane having an inner surface facing the substrate. A mounting area may be arranged to fix the membrane along at least part of the perimeter of the membrane, wherein the mounting area, the inner surface and the substrate enclose a back volume. An acoustic compliance of the back volume may be arranged to be the same or larger than an acoustic compliance of the membrane. An optical sensor may be configured to generate a sensor signal indicative of a displacement of the membrane.

### CROSS-REFERENCE TO RELATED APPLICATIONS

The present application is a national stage entry according to 35 U.S.C. § 371 of PCT application No.: PCT/US2022/022690 filed on Mar. 30, 2022; which claims priority to U.S. provisional application 63/168,664 filed on Mar. 31, 2021 and German patent application 10 2021 113 329.7 filed on May 21, 2021; all of which are incorporated herein by reference in their entirety and for all purposes.

### TECHNICAL FIELD

This disclosure relates to a displacement detector, an array of displacement detectors and to a method of manufacturing a displacement detector.

Further aspects to the disclosure relate to acoustic-electrical transducers and to detection of sound pressure, e.g. microphones, such as MEMS microphones. Another aspect relates to miniaturized microphones where a membrane displacement can be optically detected by interferometry, for example.

### BACKGROUND

Miniaturization is requested in many fields of technology, e.g. in mobile and/or wearable computing devices, such as smart phones or other communication devices, tablets, smart watches, but also elsewhere. Even though currently known microphones can be very small already, there is still demand for still much smaller devices. At the same time, the microphones should not lack in acoustical properties, e.g. frequency response, sensitivity and signal-to-noise ratio, despite being extremely small. Furthermore, there is also demand for omnidirectional microphones with ever decreasing footprint.

The art has come up with different concepts to design increasingly small displacement detectors, such as microphones or pressure sensors. For example, in MEMS devices a movement of a membrane can be detected optically by means of interferometry, e.g. by means of a Mach-Zehnder or a Michelson interferometer. Light from a laser light source is divided into two arms, one of them comprises a light path on which the light is emitted at an angle onto the membrane and then reflected from the membrane. Interference occurs upon reuniting the light of the two arms. Below the membrane, a cavity is formed, acoustic waves to be detected impinge on the membrane from outside the cavity. The microphone can be manufactured using MEMS technologies.

It is an objective to provide a displacement detector, an array of displacement detectors and a method of manufacturing a displacement detector which allow further miniaturization while keeping or even improving acoustical properties of the device.

This objective is achieved by the subject matter of the independent claim. Further developments and embodiments are described in dependent claims.

It is to be understood that any feature described in relation to any one embodiment may be used alone, or in combination with other features described herein, and may be used in combination with one or more features of any other of the embodiments, or any combination of any other of the embodiments unless described as an alternative. Furthermore, equivalents and modifications not described below may also be employed without departing from the scope of the gas sensor and the method of gas sensing which are defined in the accompanying claims.

### SUMMARY

The following relates to an improved concept in the field of displacement detectors, e.g. microphones and pressure sensors. One aspect of the proposed improved concept relates to specific choices of the acoustic compliances of membrane and integrated back volume. The proposed concept provides a framework which allows to describe the resulting very high gain in sensitivity and, at the same time, in very small dimensions. For example, suitably dimensioning a membrane (e.g. diameter) and (e.g. the shape of) the back volume can result in the observed dramatic increase in sensitivity. More particularly, implementing a larger height (of the back volume) and a smaller area (e.g., diameter) of the back volume (and of the membrane) may lead to increase in sensitivity.

Thus, according to one aspect it is suggested to implement a relatively tall (high back volume) MEMS microphone with small (low area) MEMS membrane, which effects a very high sensitivity. For example, as will be discussed in this disclosure on more detail, considering cylindrical back volumes, the height of back volume can be 300 to 600 microns, at a membrane diameter of only 250 to 500 microns. The observed gain and increase in sensitivity will be discussed in terms of an acoustical model. The gain is further supported by combining a very thin, very elastic MEMS membrane (enabled by very sensitive optical detection in contrast to capacitive detection) with a particularly dimensioned (high, tall) back volume, such that the acoustic compliances of the membrane and of the back volume relate to one another in such a way that the overall system gain and thus the system sensitivity is exceptionally large.

According to another aspect the detector employs an optical sensor, e.g. with a resonant light source. The light source can be arranged in a flip-chip configuration to yield a miniaturized overall footprint combined with good acoustical properties. For example, the light source forms a self-mixing interferometer with respect to an inner surface of a membrane to detect a displacement of the membrane with high accuracy. This is possible largely because there are no interfering contacts of the light source in the way which in other designs may distort the sensor signals. Further aspects allow to improve footprint and acoustical properties even further as will be discussed in details below.

In at least one embodiment a displacement detector comprises a substrate, a membrane, a mounting area and an optical sensor. The membrane has an inner surface which faces the substrate. Correspondingly, the membrane also has a top surface facing away from the substrate. The mounting area is arranged to fix the membrane along at least part of the perimeter of the membrane. The mounting area, the inner surface and the substrate enclose a back volume. An acoustic compliance of the back volume is arranged to be the same or larger than an acoustic compliance of the membrane.

In operation, a sound pressure may act on the membrane and induces a certain displacement depending on the degree of mechanical force acting on the membrane surface. For example, the mechanical force is established via ambient pressure or by soundwaves. By way of the resonant light source the optical sensor emits light towards the membrane which strikes the inner surface and eventually is reflected back towards the optical sensor. The sensor generates a sensor signal which is indicative of the displacement of the membrane.

The proposed displacement detector allows a high degree of miniaturization. In fact, the detector can be even further miniaturized compared to prior art solutions. While current detectors can already be very small, the proposed displacement detector can still be made much smaller. At the same time, the proposed displacement detector does not trade increased miniaturization for acoustical properties of the device. In fact, the proposed detector can have very good acoustical properties, for example a very good frequency response, sensitivity and signal-to-noise ratio, despite being extremely small. Overall footprint may be as small as around 2×2×1 mm³ to around 1×1×0.5 mm³. These numbers should be considered examples, rather than limits. Furthermore, by way of its design the proposed displacement detector has an omnidirectional characteristic and may be the basis for implementing an omnidirectional microphone.

Furthermore, the proposed displacement detector can be manufactured in a simpler process than, for example microphones known from the prior art, because no complicated substrate is required and less parts need to be assembled. Compared to capacitive detectors, optical detection of the membrane displacement allows for much thinner and lighter membranes. This results in the possibility of having very elastic membranes and a much increased sensitivity.

The proposed concept relates to specific choices of the acoustic compliances of membrane and back volume which have been found to result in a very high sensitivity and, at the same time, in very small dimensions. For example, suitably dimensioning the membrane (e.g., diameter) and (the shape of) the back volume can result in the observed dramatic increase in sensitivity. For example, the proposed compliances and ratios thereof can be met by implementing a large height (of the back volume) and a small membrane area (e.g., diameter) of the back volume (and of the membrane) can lead to the increase in sensitivity.

In at least one embodiment a ratio of the acoustic compliance of the back volume and the acoustic compliance of the membrane is equal to or greater than 1. An acousto-electrical model suggests a minimum ratio between compliances of membrane and of back volume. According to this model the acoustic compliance of the back volume is arranged to be the same or larger than an acoustic compliance of the membrane, i.e. a ratio of the acoustic compliance of the back volume and the acoustic compliance of the membrane is equal to or greater than 1.

In at least one embodiment at least part of the back volume is comprised by a cylinder of radius r and height h. A top base of the cylinder has the radius r and is comprised by the membrane. The height h of the cylinder is arranged such that the acoustic compliance of the back volume is the same or larger than the acoustic compliance of the membrane.

The displacement detector, e.g. a MEMS microphone, can be extremely miniaturized and still have a very high sensitivity (and also good acoustical properties). In terms of height and radius, the ratio is between the height of the back volume and the amount of the back volume (or the area taken by the back volume) is proposed. In one approximation, at least part of the back volume is comprised by a cylinder of radius r and height h. A top base of the cylinder has the radius r and is comprised by the membrane. The height h of the cylinder is arranged such that the acoustic compliance of the back volume is the same or larger than the acoustic compliance of the membrane.

In at least one embodiment the optical sensor further comprises a resonant light source which is arranged in a flip-chip configuration, and forming a self-mixing interferometer with respect to the inner surface.

The light source forms a self-mixing interferometer with respect to an inner surface of a membrane to detect a displacement of the membrane with high accuracy due to optical detection. This is possible largely because there are no interfering contacts of the light source in the way which in other designs may distort the sensor signals. Further aspects allow to improve footprint and acoustical properties even further as will be discussed in details below.

In at least one embodiment, the resonant light source comprises an optical resonator having an upper surface facing the inner surface of the membrane. In operation the optical resonator generates light based on a resonance process and emits said light from the upper surface towards the inner surface of the membrane. The upper surface may be free of electrical contacts, which in the flip-chip configuration rather are positioned on a lower, and opposite, surface. Thus, contacts do not interfere with the acoustics of the back volume and effectively use no additional space but the one below the light source.

The use of an optical resonator has the effect of supporting self-mixing interference inside the back volume. In self-mixing interference light is emitted from a resonant light source (having an optical resonator in which the light circulates), e.g. a laser, and feeds back into the resonator a portion of the light having excited the resonator, for example, after the light has interacted with the membrane, e.g. by refraction or scattering. The feedback light interacts with the light in the resonator by introducing a disturbance in the light source by interference. This effect can be sensed and can be related to the interaction with the membrane. For example a distance to the membrane or (relative to the light source/resonator exit mirror) can be deduced. Sensing can be accomplished in different ways including optical and electrical detection. As a result, a sensor signal is generated which is indicative of the displacement of the membrane.

In at least one embodiment the resonant light source comprises a vertical-cavity surface-emitting laser, VCSEL, having a front-side and a back-side. The upper surface comprises the back-side of the vertical-cavity surface-emitting laser, and the front-side comprises the lower surface of the light vertical-cavity surface-emitting laser.

The VCSEL laser diode is a convenient optical resonator light source which is readily available in different wavelength ranges including infrared. In fact, modern VCSEL laser diodes can be manufactured at small footprint and, thus, support miniaturization of the displacement detector. Furthermore, VCSEL laser diodes may have emission also on their bottom side, rather than the top surface. This allows for space saving flip-chip configuration using the contacts downwards, i.e. facing the substrate.

In at least one embodiment the light source comprises one or more electrical contact pads which are arranged at a lower surface of the light source and opposite the upper surface. The contact pads are arranged to provide, or allow for, flip-chip configuration. Light sources, for example VCSEL laser diodes, typically emit light via their front surfaces. In the flip-chip configuration basically the light source is turned upside-down with its front surface facing away from the membrane. The back surface, which is free of contact pads, faces the membrane such that no contact pads interfere with the detection path.

In at least one embodiment the substrate is formed by a substrate of the light source. The contact pads are arranged to electrically contact the displacement detector. Miniaturization can be extended to a higher degree by effectively using the substrate of the light source as the substrate of the displacement detector. In this way the substrate is not necessary as an additional component as it is already provided by the light source itself. This enables yet smaller overall footprints to be implemented. The displacement detector can be arranged on a printed circuit board with contact pads providing electrical contact, e.g. for control or data acquisition.

Light sources, for example VCSEL laser diodes, typically emit light via their front surfaces. In the flip-chip configuration basically the light source is turned upside-down with its front surface facing away from the membrane. The back surface, which is free of contact pads, faces the membrane such that no contact pads interfere with the detection path.

In at least one embodiment the membrane is a MEMS membrane. MEMS membranes can be very elastic and thin. The use of MEMS membranes is possible due to optical detection and leads to a much increased sensitivity compared to capacitive membranes, for example.

In at least one embodiment a lens for collimating and/or focusing light to be emitted by the light source is attached to or integrated into the light source. The design of the VCSEL laser allows to arrange for integration of the lens on top of the VCSEL laser and thereby adjust a light path for detection. Collimation and/or focusing towards the inner surface may increase signal-to-noise ratio.

In at least one embodiment the displacement detector is further configured as a microphone or as a pressure sensor.

In at least one embodiment an array of displacement detectors comprises one or more displacement detectors. The displacement detectors are arranged in an array structure.

Combining two or more of the omnidirectional displacement detectors, further functions can be achieved, including directionality, beam forming, sound Localization and SNR increase by 10*log M where M is number of displacement detectors operating in parallel.

In at least one embodiment a method for manufacturing a displacement detector comprises the steps of providing a substrate and a membrane having a reflective inner surface. The membrane is fixed to a mounting area along at least part of the perimeter of the membrane. In this way, the inner surface faces the substrate and the mounting area, the inner surface and the substrate enclose a back volume. Furthermore, an optical sensor is provided comprising a resonant light source. The light source is arranged in a flip-chip configuration, thereby forming a self-mixing interferometer with respect to the inner surface to be to operate a sensor signal which is indicative of a displacement of the membrane.

In at least one embodiment a ratio of the acoustic compliance of the back volume and the acoustic compliance of the membrane is set to be equal to or greater than 1.

In at least one embodiment at least part of the back volume is comprised by a cylinder of radius r. A top base of the cylinder has the radius r and is comprised by the membrane. The height h of the cylinder is arranged such that the acoustic compliance of the back volume is the same or larger than the acoustic compliance of the membrane.

In at least one embodiment the optical sensor further comprises a resonant light source and the method involves arranging the light source in a flip-chip configuration, and forming a self-mixing interferometer with respect to the inner surface.

Further embodiments of the method for manufacturing a displacement detector according to the improved concept become apparent to a person skilled in the art from the embodiments of the displacement detector and array of displacement detectors described above, and vice versa.

In conclusion, it is suggested that the back volume of the displacement detector, e.g. a MEMS microphone, can be large basically because it can be a large height of the back volume, whereas the area (or diameter) of the membrane (and of the back volume) may be relatively small. Tunability of the displacement detector sensitivity can be affected by suitably dimensioning the compliance of the membrane and the compliance of the back volume and/or by suitably shaping/dimensioning the back volume. Effectively, displacement detector, e.g. a MEMS microphone, according to the proposed concept can be very much smaller than prior art devices, while having good acoustical properties, including, importantly, a high sensitivity, but also a good frequency response, and it can have an omnidirectional characteristic. It is far from trivial to gain the insight that a dramatic increase in sensitivity can be obtained in the proposed way. One way to implement the proposed concept is by combining a very thin, very elastic MEMS membrane (enabled by very sensitive optical detection) with a particularly dimensioned (high, tall) back volume, such that the acoustic compliances of the membrane and of the back volume relate to one another in such a way that the overall system gain and thus the sensitivity is exceptionally large. For example, considering cylindrical back volumes, as an example only the height of back volume can be 300 to 600 μm, at a membrane diameter of only 250 to 500 μm.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures.

### BRIEF DESCRIPTION OF THE DRAWINGS

In the Figures:

FIG. 1 shows a first example embodiment of a displacement detector,

FIG. 2 shows the first example embodiment of a displacement detector from different orientations,

FIG. 3 shows a second example embodiment of a displacement detector,

FIG. 4 shows the second example embodiment of a displacement detector from different orientations,

FIG. 5 shows a third example embodiment of a displacement detector,

FIG. 6 shows the third example embodiment of a displacement detector from different orientations,

FIG. 7 shows a fourth example embodiment of a displacement detector,

FIG. 8 shows an acousto-electrical model for an example displacement detector, and

FIG. 9 shows example dependencies between a system gain and the membrane radius.

### DETAILED DESCRIPTION

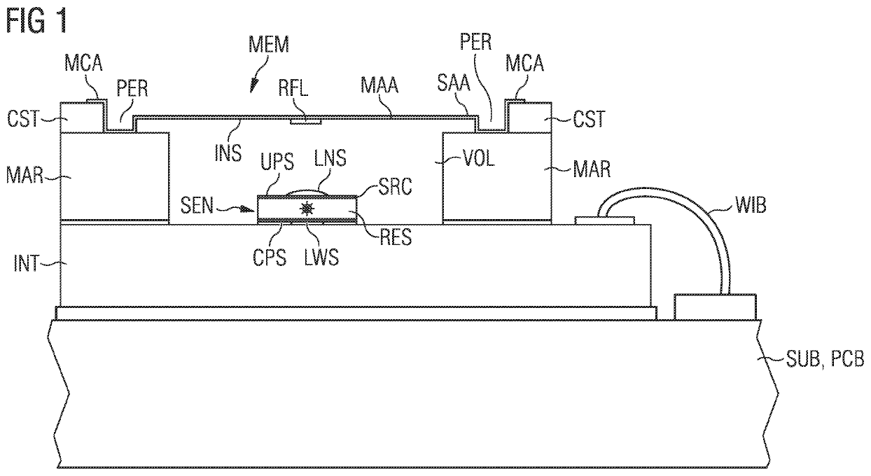

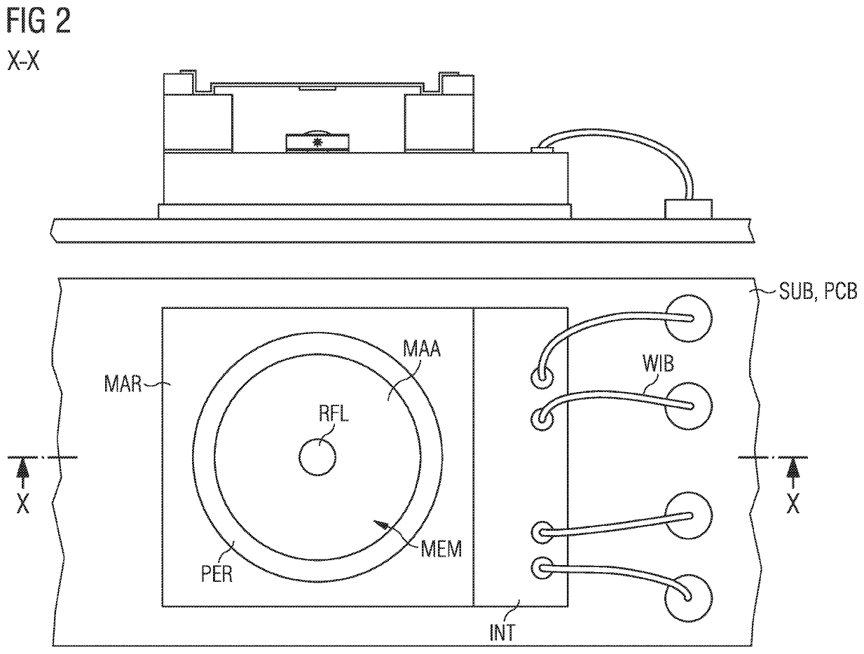

FIG. 1 shows a first example embodiment of a displacement detector. FIG. 2 shows the first example embodiment of a displacement detector from different orientations. In the top FIG. 2 shows the displacement detector of FIG. 1, i.e. in side view, and in the bottom the drawing shows the same displacement detector in top view. The first example embodiment provides an assembly option with a MEMS membrane and a VCSEL chip attached to a substrate die. The displacement detector comprises a substrate SUB, a membrane MEM and an optical sensor SEN.

The substrate SUB comprises a printed circuit board PCB. The substrate and printed circuit board mechanically support and electrically connect the components of the displacement detector using conductive tracks, pads and other features. For example, the printed circuit board further supports and electrically connects electronic components to control operation of the displacement detector. Such components include ADCs, microcontrollers, ASICs, or other integrated circuits. This way the displacement detector may be packed into a highly modular module, which can be configured as a microphone or as a pressure sensor, for example.

In this embodiment an interposer INT is arranged on the substrate SUB. For example, the interposer is arranged on and connected to the printed circuit board to provide electrical contacts to the board and/or substrate. The interposer acts as an electrical interface routing between the substrate/printed circuit board and their electronic components and the displacement detector, including the optical sensor, for example. In the drawing the substrate/printed circuit board and the interposer are electrically connected by means of one or more wire bonds WIB.

A mounting area MAR is arranged on the interposer. The mounting area mechanically supports and fixes the membrane along at least part of the perimeter PER of the membrane. In this embodiment the mounting area provides a cavity which encloses the optical sensor. For example, the membrane and mounting area are part of the same wafer substrate. The membrane is made by deposition on the wafer substrate and the mounting area is made by DRIE etching from the back side on the same wafer substrate. The mounting area, the membrane and the interposer enclose a back volume VOL. The back volume is essentially closed but may be have one or more openings for static pressure equalization (not shown). Optionally, the back volume may comprise a damping volume, which can be disposed adjacent to the perimeter PER of the membrane (not shown).

The membrane is a MEMS membrane, i.e. is manufactured by means of micro-electro mechanical systems (MEMS) technology.

For example, the membrane is composed of low stress silicon nitride and can be made extremely thin. The membrane is mechanically supported and fixed to the mounting area along the perimeter PER of the membrane. The perimeter separates the membrane into an active area MAA and a contact area MCA. Furthermore, the mounting area comprises a contact section CST which receives and additionally fixes the contact area MCA of the membrane. A section SAA of active area MAA is at a distance with respect to the mounting area. The resulting gap or slit allows the membrane to freely vibrate with damped response.

The membrane MEM comprises an inner surface INS which faces the interposer INT. The membrane may, optionally, be equipped with a reflective patch RFL. The reflective patch can be arranged on the inner surface INS of the membrane, on a top surface of the membrane or embedded in the membrane, for example.

For example, a thickness of the membrane material can be reduced where a reflective patch RFL is, and the membrane material covers the reflective patch. In contrast to the (valid) option of positioning the reflective patch on a membrane of constant thickness (near where the reflective patch is), this makes the membrane properties (mass and elasticity) more homogeneous, leading to better acoustic properties, and the mass of the membrane is not or not much increased by the application of the reflective patch. And by covering the material of the reflective patch with the material of the membrane, the material of the reflective patch can be protected from corrosion. This can be useful for materials like Al for the reflective patch—which is rather corrosive and very light.

A typical way of producing the patch, embedded or not, is to grow/deposit it, e.g., by sputtering. Material of the reflective patch may usually include a metal, e.g., Au or Al. Through its lightness, Al is a good choice. The membrane material, however, can be a semiconductor material, such as SiN or polycrystalline Si. Another, potentially simpler option for the reflective patch can be similar to the embedding above, but without covering the reflective patch. The thickness of the membrane material can be reduced where the reflective patch is, thus saving weight and gaining homogeneity, but eventually decreasing corrosion protection.

The optical sensor SEN is arranged on and electrically connected to the interposer INT. The optical sensor further comprises a resonant light source SRC, which in this embodiment is a vertical-cavity surface-emitting laser, VCSEL. A VCSEL is a type of resonant semiconductor laser diode with laser beam emission perpendicular from a top surface of an optical resonator RES. However, in this embodiment the VCSEL is arranged in a flip-chip configuration, i.e. with its top surface facing the interposer. An upper surface UPS of the resonator faces the inner surface INS of the membrane. In fact, there is also laser beam emission perpendicular from the upper surface UPS, which is directed towards the membrane. The optical resonator generates light based on a resonance process and emits said light from the upper surface towards the inner surface of the membrane.

The VCSEL comprises one or more electrical contact pads CPS which are arranged at a lower surface LWS (or top surface of the optical resonator) and opposite of the upper surface UPS.

The contact pads lie below the VCSEL in the sense that, in top view, the contact pads are fully covered by the optical resonator. Thus, the contact pads are essentially not in the back volume and, thus, do not interfere with the acoustical properties of the back volume. No additional space needs to be reserved in the back volume for electrical contacting, e.g. by wire bonds, which would indeed not only require space but alter the acoustical properties of the back volume.

Optionally, a lens LNS is attached to or integrated into the light source, i.e. in this embodiment the VCSEL laser. The lens can be arranged for collimating light emitted by the VCSEL. A light path between the lens and the inner surface of the membrane may be free of optical elements. The light source/VCSEL is implemented as a flip chip. The lens can be produced by removing material from a substrate of the VCSEL (backside etching). For example, a GaAs substrate can be used for the manufacture of the VCSEL, and, typically after having completed the manufacture of the VCSEL, said substrate is etched, so as to form the lens therein.

In operation, the resonant light source, i.e. VCSEL, of the optical sensor emits light towards the membrane. Light eventually is reflected back from the membrane, e.g. by the reflective patch RFL and is fed back into the optical resonator of the VCSEL. The feed-back light interacts with the light in the optical resonator and introduces a disturbance in the light source by interference. This effect can be sensed by the detector unit DUN (not shown) of the optical sensor which, in turn, generates a sensor signal indicative of a displacement of the membrane, e.g. relative to the light source/a resonator exit mirror.

Sensing can be accomplished in different ways, e.g. optically or electrically. For an optical detection the optical sensor comprises a photodiode, or other type of photo detector. The emitted light intensity can be monitored, e.g., using the photodiode. For example, a beam splitter can be positioned close to an exit mirror of the optical resonator RES to let pass most of the light exiting the exit mirror and reflect a small portion thereof to a photodetector. Alternatively, a second, non-exit, mirror of the optical resonator RES can be made partially transparent (e.g., 99% instead of 100% reflective), and the photo detector is positioned close that mirror. This can be a more compact solution.

For an electrical detection the detector unit DUN is arranged to monitor a feed signal for the light source. For example, the light source can be driven with constant current. Then, the detector unit DUN determines a change in voltage, which can be related to a displacement of the membrane. In another embodiment the light source is driven with constant voltage, and the change in current is determined by the detector unit. The electrical signal usually is noisier than the optically obtained signal but may be implemented by simple voltage/current sensing components.

SMI-based sensors, i.e. optical sensor which form a self-mixing interferometer with the object to be measured, can be very compact and small. Self-mixing interferometry, or SMI, allows for absolute distance and velocity measurements. Detection of displacement of the membrane can be within less than one wavelength of light and/or within ±180° phase. For example, detection of membrane movements of less than ±25 nm, or of less than ±15 nm is possible. VCSELs (vertical-cavity surface emitting lasers) can be used for SMI, which are very small and cost efficient.

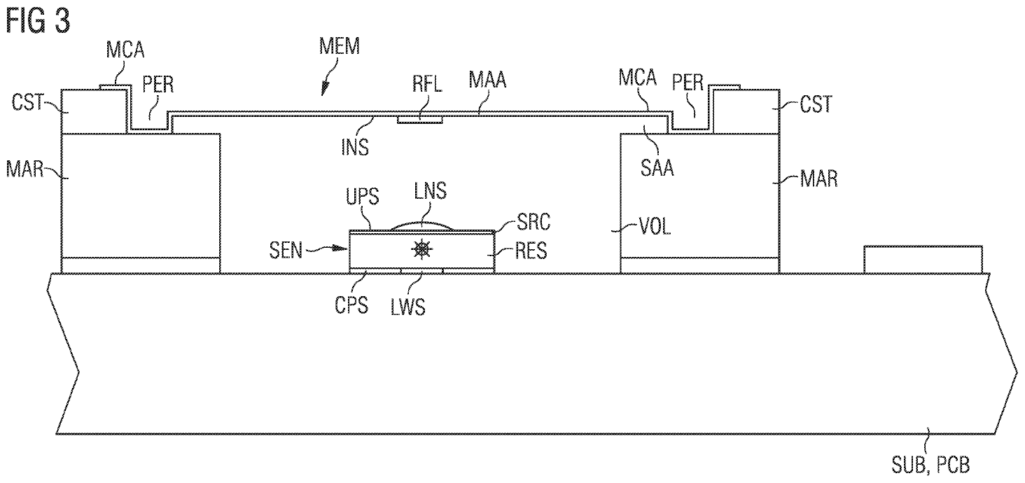

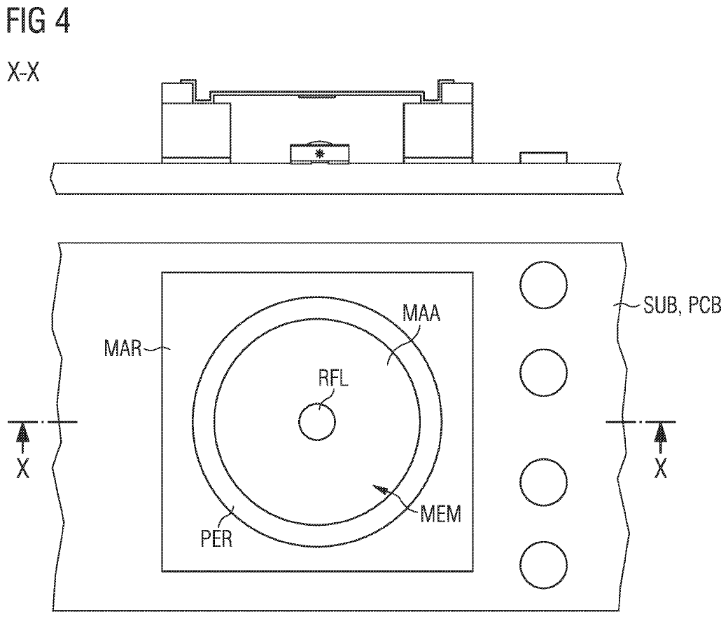

FIG. 3 shows a second example embodiment of a displacement detector. FIG. 4 shows the second example embodiment of a displacement detector from different orientations. In the top the drawing shows the displacement detector of FIG. 3, i.e. in side view, and in the bottom the same displacement detector is depicted in top view. The second example embodiment is based on the first example embodiment. Differences will be discussed below. The second example embodiment provides an assembly option with a MEMS membrane die attached and VCSEL chip bonded on the printed circuit board.

In this embodiment the mounting area MAR is arranged on the substrate without an interposer in-between. The mounting area, the membrane and the substrate SUB enclose the back volume VOL. During manufacture the mounting area is aligned with respect to the printed circuit board, e.g. with respect to its electronic components, which requires a highly accurate placing of the PCB. The interposer may loosen this requirement. The optical sensor SEN is arranged on and electrically connected to the substrate, e.g. to the printed circuit board. Thus, there may be no need for wire bonds as compared to the first embodiment, which renders this embodiment more compact.

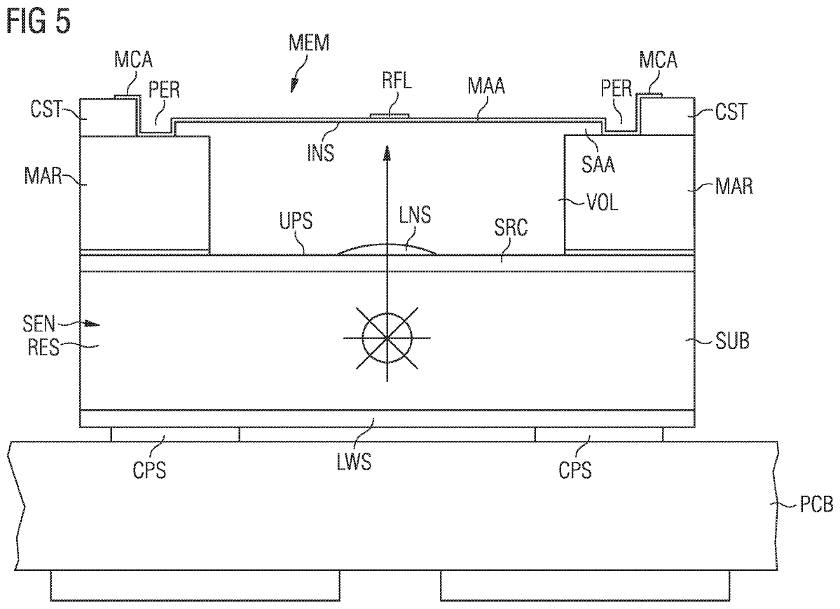

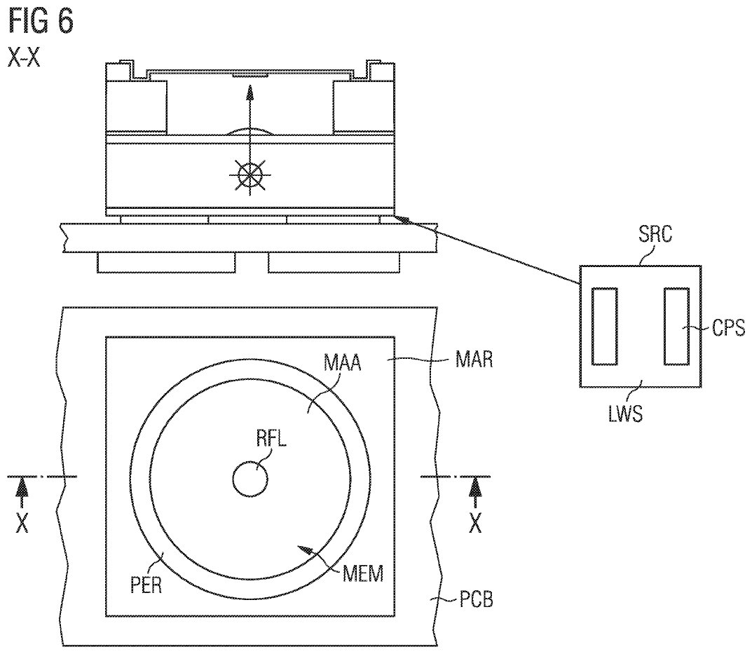

FIG. 5 shows a third example embodiment of a displacement detector. FIG. 6 shows the third example embodiment of a displacement detector from different orientations. In the top the drawing in FIG. 6 shows the displacement detector of FIG. 5, i.e. in side view, and in the bottom shows the same displacement detector in top view. This embodiment provides an assembly option as a stand-alone package with the mounting area mounted on the light source/VCSEL. Thus, the light source functions as substrate or interposer. The substrate SUB is formed by a substrate of the light source, i.e. the VCSEL laser diode.

The vertical-cavity surface-emitting laser, VCSEL, has a front-side and a back-side. The upper surface UPS comprises the back-side of the vertical-cavity surface-emitting laser, and the front-side of the light vertical-cavity surface-emitting laser comprises the lower surface LWS. Contact pads CPS are arranged at the lower surface to electrically contact the displacement detector. The substrate of the VCSEL provides the substrate SUB. The mounting area MAR is arranged on the substrate of the VCSEL. Consequently, the mounting area, the membrane and the substrate of the VCSEL enclose the back volume VOL. The back volume is limited by the substrate of the VCSEL. Similar to the other embodiments a lens LNS is placed on the VCSEL for collimating and/or focusing light on the membrane. The displacement detector (based on the VCSEL) may be arranged on and by means of the contact pads be electrically connected to a printed circuit board PCB. The printed circuit board can be considered an external component to interact and/or control the displacement detector.

In this embodiment the overall footprint is determined and only limited by the size of the light source, i.e. the VCSEL chip.

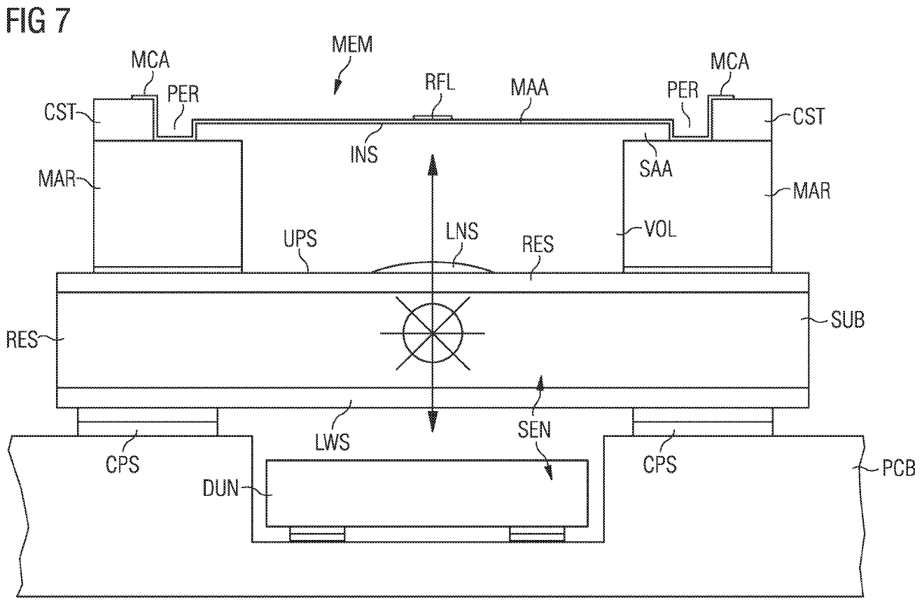

FIG. 7 shows a fourth example embodiment of a displacement detector. This embodiment is based on the third embodiment. In addition, it shows a detector unit DU of the optical sensor SEN. The detector unit is arranged on or in the printed circuit board PCB. The detector unit may be optical, i.e. comprises a photodetector like a photodiode to detect an amount of light emitted by the light source via its lower surface LWS. As discussed above, in an alternative embodiment, the detector unit may be electrical, i.e. comprises a voltage or current meter to detect characteristic voltage or current of the light source.

In following aspects of an acousto-mechanical model will be discussed. These aspects can be combined with the proposed concept discussed above. The acousto-mechanical model suggests choices of the acoustic compliances of membrane and back volume resulting in high sensitivity and small dimensions via suitably dimensioning the membrane and the back volume, more particularly the height vs. area of the back volume.

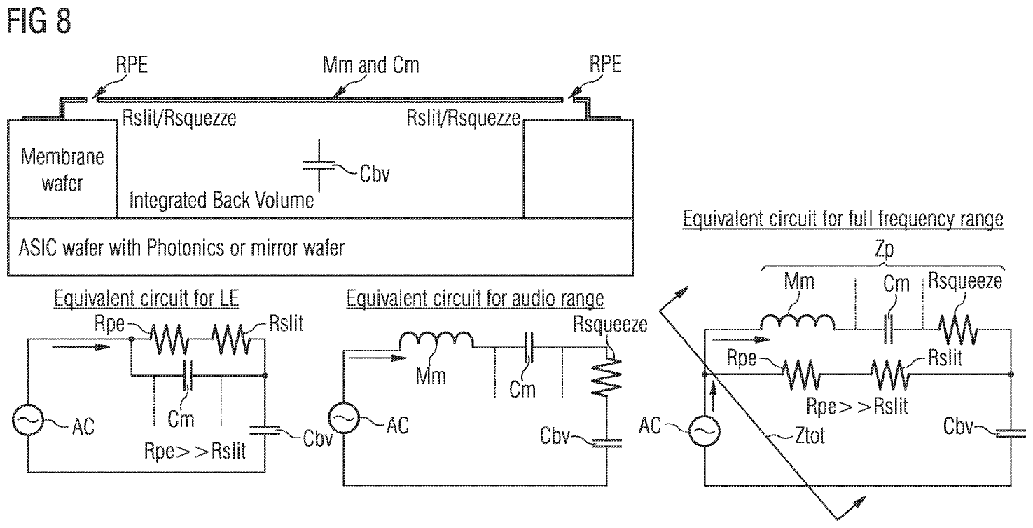

FIG. 8 shows an acousto-electrical model for an example displacement detector. The model assumes a displacement detector based on the second embodiment, i.e. the mounting area is arranged on the substrate without intervening interposer. The derivation discussed for this example applies also to the outer embodiments. Differences in structure and layout can be adjusted as needed. The displacement detector depicted in the upper part of the drawings comprises the MEMS membrane discussed above. However, the back volume is not completely closed but comprises openings PEQ for static pressure equalization. The optical sensor (including the resonant light source) is not depicted for easier representation.

In order to simplify calculations the displacement detector can be represented by an equivalent circuit. This circuit refers to a theoretical circuit that retains all of the acoustical characteristics in terms of an electronic circuit. The membrane is represented by its moving mass Mₘ and gives rise to a compliance cₘ (which for the sake of the calculation can be considered equivalent to a capacity). The openings for static pressure equalization can be considered resistances which are denoted as Rₚₑ. Furthermore, during operation as the MEMS membrane vibrates air may be squeezed to a certain degree in the gap or slit between mounting area and section SAA of active area MAA. This effect can be represented by another resistance, denoted Rₛₗᵢₜ. In addition, the membrane material may also be squeezed the MEMS membrane vibrates. This effect can be represented by another resistance, denoted R_{squeeze}. The back volume gives rise to a compliance c_{bv} (which for the sake of the calculation can be considered equivalent to a capacity).

A first equivalent circuit (1) describes the behavior of the displacement circuit for low frequencies, LF. Low frequencies are those smaller than those of the audio range. A current source AC in the circuit represents an audio source, or generally an input sound pressure Pᵢₙ. Correspondingly, an output sound pressure is denoted Pₒᵤₜ. The compliance cₘ determines the output sound pressure Pₒᵤₜ. A volume velocity is denoted by the arrow in the circuit drawing. The membrane is shown as a mechanical compliance cₘ in parallel with acoustic resistances Rₛₗᵢₜ and Rₚₑ. R_{squeeze} can be neglected for LF. Furthermore, it is safe to assume Rₚₑ>>Rₛₗᵢₜ. This parallel circuit is further connected in series with the compliance c_{bv} of the back volume. In these terms the ratio of input sound pressure Pᵢₙ and output sound pressure Pₒᵤₜ yields:

$$\frac{{P}_{out}}{{P}_{in}} = \frac{( s \cdot ( {R}_{pe} + {R}_{slit} ) \cdot {c}_{bv} )}{1 + s \cdot ( {R}_{pe} + {R}_{slit} ) \cdot ( {c}_{bv} + {c}_{m} )}$$

wherein s=jω is the Laplace variable. A high pass frequency flip (typically in the range of 20 Hz) can be expressed as:

$${f}_{HP} = \frac{1}{2 π ( {R}_{pe} + {R}_{slit} ) \cdot ( {c}_{bv} + {c}_{m} )} .$$

A second equivalent circuit (2) describes the behavior of the displacement circuit for the audio range. Mass Mₘ can be represented as an inductance in series with the compliance cm which determines the output sound pressure Pₒᵤₜ. For the audio range R_{squeeze} is considered and Rₛₗᵢₜ can be neglected. Rsqueeze and the compliance c_{bv} of the back volume are connected in series. For this equivalent the following expressions hold:

$${w}_{0} = \frac{1}{\sqrt{{M}_{m} \cdot ( \frac{( {c}_{bv} \cdot {c}_{m} )}{( {c}_{bv} + {c}_{m} )} )}} ,$$

$$and$$

$$df = ( \frac{1}{2} {R}_{squeeze} \cdot \sqrt{\frac{1}{{M}_{m}} \frac{( {c}_{bv} \cdot {c}_{m} )}{( {c}_{bv} + {c}_{m} )}} ) ,$$

wherein df denotes a system damping factor and wo system resonance frequency (for a membrane loaded with back volume compliance). In these terms the ratio of input sound pressure Pᵢₙ and output sound pressure Pₒᵤₜ yields:

$$\frac{{P}_{out}}{{P}_{in}} = \frac{{c}_{bv}}{( {c}_{bv} + {c}_{m} )} .$$

A third equivalent circuit (3) combines the (1) and (2) to arrive at an equivalent circuit for the full frequency range of the displacement detector. Zₚ and Zₜₒₜ denote equivalent impedance of the membrane and total impedance as denoted in the drawing (3), respectively. Now the total transfer function Hₜₒₜₐₗ can be determined using the abbreviations defined in the calculation below:

$${P}_{out} = {V}_{mic} \cdot \frac{1}{s \cdot {c}_{m}} = \frac{{R}_{pe}}{{Z}_{p} + {R}_{pe}} \cdot {V}_{in} \cdot \frac{1}{s \cdot {c}_{m}}$$

$${V}_{mic} = \frac{{R}_{pe}}{{Z}_{p} + {R}_{pe}} \cdot {V}_{in}$$

$${V}_{in} = \frac{{P}_{in}}{{Z}_{tot}}$$

$${Z}_{P} = s \cdot {M}_{m} + \frac{1}{s \cdot {c}_{m}} + {R}_{squeeze}$$

$${Z}_{tot} = \frac{{R}_{pe} \cdot {Z}_{p}}{{R}_{pe} + {Z}_{p}} + \frac{1}{s \cdot {c}_{bv}}$$

With these terms the ratio of input sound pressure Pᵢₙ and output sound pressure Pₒᵤₜ, or system gain P, yields:

$$\frac{{P}_{out}}{{P}_{in}} = \frac{{R}_{pe}}{{R}_{pe} + {Z}_{p}} \cdot \frac{1}{{Z}_{tot}} \cdot \frac{1}{s \cdot {c}_{m}} = {H}_{pe , transf} \cdot {H}_{m , transf} = {H}_{tot} .$$

As per this acousto-electrical model, the system gain P is, in a good approximation, proportional to the ratio of the compliance of the back volume c_{bv} divided by the sum of the compliance of the back volume c_{bv} and the compliance of the membrane cₘ:

$$P ∼ \frac{{c}_{bv}}{( {c}_{bv} + {c}_{m} )} .$$

And in the simple case of a (at least partial) cylindrical back volume of height h and radius r (corresponding to the radius of the membrane), in a good approximation, the following proportionalities hold: c_{bv}˜h and cₘ˜r². Thus:

$$P ∼ \frac{h}{h + x \cdot {r}^{2}} ,$$

wherein x is a constant independent of mechanical or acoustical parameters of the displacement detector. In other words, in order to increase the system gain P, one can choose a large height h and a small radius r. The amount of back volume may be increased by making it tall (large height, at small area or diameter). This is contrary to the popular approach which typically suggests to increase the area (or diameter) of the membrane or back plate. This finding is due to the fact that membrane compliance is a mechanical parameter. To transfer it into an acoustic parameter, membrane mechanical compliance has to be multiplied by the square of the membrane area. Therefore, by increasing membrane (and back volume) diameter, membrane acoustical compliance is increasing by a factor of r⁴, where back volume compliance is increasing by only r². As shown above that will not help to increase system level gain P.

In conclusion, the acousto-electrical model suggests a minimum ratio between compliances of membrane and of back volume. For example, the acoustic compliance of the back volume is arranged to be the same or larger than an acoustic compliance of the membrane, i.e. a ratio of the acoustic compliance of the back volume and the acoustic compliance of the membrane is equal to or greater than 1. The displacement detector, e.g. a MEMS microphone, can be extremely miniaturized and still have a very high sensitivity (and also good acoustical properties). In terms of height and radius, the ratio is between the height of the back volume and the amount of the back volume (or the area taken by the back volume) is proposed. In one approximation, at least part of the back volume is comprised by a cylinder of radius r and height h. A top base of the cylinder has the radius r and is comprised by the membrane. The height h of the cylinder is arranged such that the acoustic compliance of the back volume is the same or larger than the acoustic compliance of the membrane.

The following example dimensions have been found to match the acousto-electrical model:
Membrane diameter (embodiments 1, 2): 900-1200 μm
Membrane diameter (embodiment 3): 200-500 μm
Reflective patch diameter (embodiments 1, 2): 60-120 μm
Reflective patch diameter (embodiment 3): 40-75 μm
Height of back volume: 200-600 μm
Height of VCSEL: 100-250 μm
Lateral dimension of VCSEL (embodiments 1, 2): 100-350 μm
Lateral dimension of VCSEL (embodiment 2): 400-1200 μm
Lens diameter (embodiments 1, 2): 90-100 μm
Lens diameter (embodiment 3): 80-100 μm
Approx. outer dimensions (L×W×H) of microphone (embodiments 1): 2×2×1 mm³
Approx. outer dimensions of microphone (embodiment 2—without substrate/PCB): 1.6×1.6×0.8 mm3
Approx. outer dimensions of microphone (embodiment 3): 1×1×0.6 mm3

These values should be considered as examples and do not limit the proposed concept in any way.

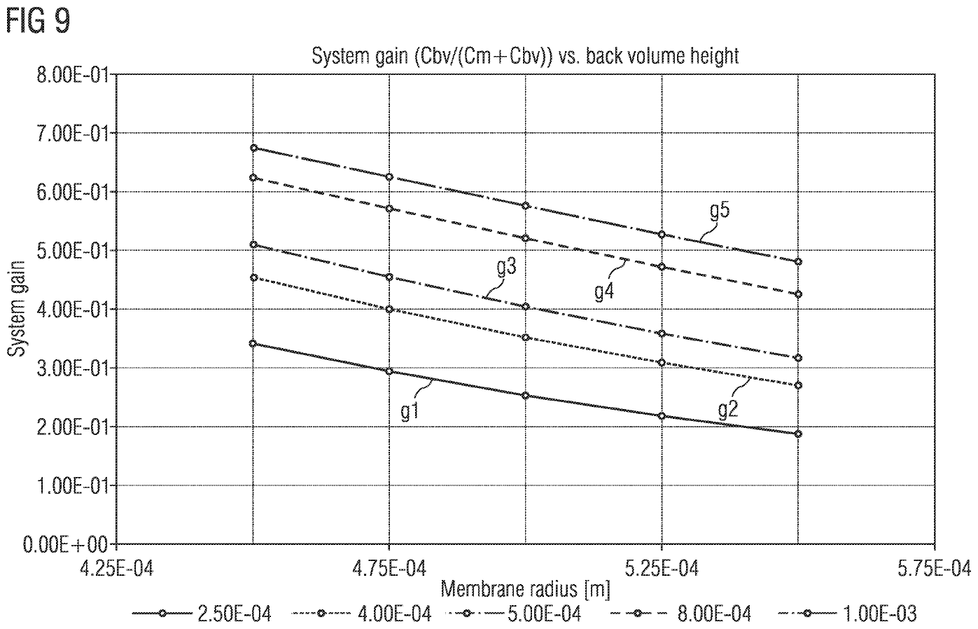

FIG. 9 shows example dependencies between a system gain and the membrane radius. Approximating the back volume as a cylinder, the membrane being circular and having approximately the same diameter as the back volume, typical high-sensitivity MEMS microphones can have dimensions as follows. Example 1: the height h of back volume can be 250 to 600 μm, at a membrane diameter d of 900 to 1200 μm. Example 2: The height h of back volume can be 250 to 600 μm, at a membrane diameter d of only 250 to 500 μm. The graph shows example dependencies between the system gain (y-axis) and the membrane radius (x-axis), for various heights between 250 microns and 1000 μm. Highest system gain has been observed for smallest diameters and increasing height. Graph g1 is at h=250, g2=400, g3=500, g4=800 and g5=1000 μm.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

Wherever acoustic waves/sound needs to be detected by means of an extremely miniaturized microphone, the proposed concept is likely to be applicable. In particular, if good acoustic performance is required. Applications are numerous and can be in the field of mobile and/or wearable computing devices, such as smart phones, tablets, smart watches, other communication devices; but also elsewhere.

Embodiments of the displacement detector may include one or more of the aspects summarized below. For example, further aspects relate to a MEMS microphone comprising a membrane having a perimeter and an inside surface, a substrate, a mounting structure is mounted on the substrate, the membrane being fixed to the mounting structure at its perimeter. An essentially closed back volume is disposed between the inside surface and the substrate, surrounded by the mounting structure. A reflective patch is present centrally on the inside surface. An SMI-based sensor comprising a light source having an upper side facing the membrane, the light source comprising an optical resonator, the light source is arranged to emit light, out of the resonator and from the upper side, onto the reflective patch and to receive back the reflected light in the resonator.

In some embodiments, the mounting structure is mounted on the upper side of the light source (the light source this constituting the substrate). The membrane is a MEMS membrane, e.g., made from SiN or polycrystalline Si. The back volume is closed except for openings for static pressure equalization. The back volume comprises a damping volume damping volume is disposed adjacent the membrane at the perimeter. The perimeter of the membrane may be circular or square (with possibly rounded corners). The reflective patch may have higher reflectivity than neighboring portions of inside surface of membrane.

A lens may be integrated in a substrate of the light source/VCSEL and may be produced by backside etching, e.g. in a GaAs substrate (of the VCSEL. The light source comprises an optical resonator comprising a first and a second end mirror, for example. The light source is arranged to emit light onto the reflective patch substantially at a right angle. The light source has electrical contact pads at a lower side which face the substrate; light source may be mounted on the substrate by means of the contact pads and is in electrical (and galvanic) connection to the substrate via the contact pads. Or the substrate is an interposer, the interposer providing electrical contacts of the displacement detector. The substrate may also be formed by the substrate of the light source; then the light source has electrical contact pads at the lower side which faces the substrate; the contact pads constitute electrical contacts of the displacement detector. The optical sensor/light source comprises or forms the substrate.

1. A displacement detector comprising:
a substrate;
a membrane having an inner surface facing the substrate;
a mounting area arranged to fix the membrane along at least part of the perimeter of the membrane, wherein the mounting area, the inner surface and the substrate enclose a back volume, and wherein an acoustic compliance of the back volume is arranged to be the same or larger than an acoustic compliance of the membranes; and
an optical sensor configured to generate a sensor signal indicative of a displacement of the membrane.

2. The displacement detector according to claim 1, wherein a ratio of the acoustic compliance of the back volume and the acoustic compliance of the membrane is equal to or greater than 1.

3. The displacement detector according to claim 1, wherein:
at least part of the back volume is comprised by a cylinder of radius r and height h,
a top base of the cylinder has the radius r and is comprised by the membrane, and
the height h of the cylinder is arranged such that the acoustic compliance of the back volume is the same or larger than the acoustic compliance of the membrane.

4. The displacement detector according to claim 1, wherein the optical sensor further comprises a resonant light source arranged in a flip-chip configuration, and forming a self-mixing interferometer with respect to the inner surface (INS).

5. The displacement detector according to claim 1, wherein:
the resonant light source comprises an optical resonator having an upper surface facing the inner surface of the membrane, and
the optical resonator is configured to generate light based on a resonance process and is configured to emit said light from the upper surface towards the inner surface of the membrane.

6. The displacement detector according to claim 1, wherein:
the substrate is formed by a substrate of the light source, and
one or more electrical contact pads are arranged on a lower surface of the light source to electrically contact the displacement detector.

7. The displacement detector according to claim 6, wherein the resonant light source comprises:
a vertical-cavity surface-emitting laser (VCSEL) having a front-side and a back-side,
the upper surface comprises the back-side of the vertical-cavity surface-emitting laser, and
the front-side comprises the lower surface of the light vertical-cavity surface-emitting laser.

8. The displacement detector according to claim 1, wherein the membrane is a MEMS membrane.

9. The displacement detector according to claim 1, wherein a lens for collimating and/or focusing light to be emitted by the light source is attached to or integrated into the light source.

10. The displacement detector according to claim 1, further configured as a microphone or as a pressure sensor.

11. An array of displacement detectors comprising:
two or more displacement detectors according to claim 1, wherein the two or more displacement detectors are arranged in an array.

12. A method for manufacturing a displacement detector, wherein the method comprises:
providing a substrate and a membrane having a reflective inner surface;
fixing the membrane to a mounting area along at least part of the perimeter of the membrane and facing the substrate, wherein the mounting area, the inner surface and the substrate enclose a back volume;
arranging an acoustic compliance of the back volume to be the same or larger than an acoustic compliance of the membrane; and
placing an optical sensor into the back volume, wherein the optical sensor is configured to generate a sensor signal indicative of a displacement of the membrane.

13. The method according to claim 12, wherein a ratio of the acoustic compliance of the back volume and the acoustic compliance of the membrane is set to be equal to or greater than 1.

14. The method according to claim 12, wherein:
at least part of the back volume is comprised by a cylinder of radius r; such that:
a top base of the cylinder has the radius r and is comprised by the membrane, and such that:
the height h of the cylinder is arranged such that the acoustic compliance of the back volume is the same or larger than the acoustic compliance of the membrane.

15. The method according to claim 12, wherein the optical sensor further comprises a resonant light source and the method involves arranging the light source in a flip-chip configuration, and forming a self-mixing interferometer with respect to the inner surface.
